(19) United States
(12) Patent Application Publication
(10) Pub. No.: US 2013/0297677 A1
(43) Pub. Date: Nov. 7, 2013

(54) TERMINAL DESKTOP PROCESSING SYSTEM, TERMINAL, SERVER AND METHOD

(71) Applicants: Xin Wan, Shenzhen City (CN); Tao Yu, Shenzhen City (CN)

(72) Inventors: Xin Wan, Shenzhen City (CN); Tao Yu, Shenzhen City (CN)

(73) Assignee: TENCENT TECHNOLOGY SHENZHEN COMPANY LIMITED, Guangdong (CN)

(21) Appl. No.: 13/823,568

(22) PCT Filed: Dec. 19, 2011
(86) PCT No.: PCT/CN2011/084185

§ 371 Date: Mar. 14, 2013

(30) Foreign Application Priority Data
Jan. 27, 2011 (CN) 201110029326.3

(51) Int. Cl. H04L 29/08

(52) U.S. Cl. CPC H04L 67/10
USPC 709/203

(57) ABSTRACT

Disclosed are a terminal desktop processing system, a terminal, a server and a method. The system includes a terminal for executing network application software and a server connected with the terminal via a network. The terminal includes a scanning module for scanning desktop layout of the application software to obtain desktop layout information of the application software; a transmission module for transmitting the desktop layout information to a server via the network; a reading module for requesting the server for desktop layout information and reading the desktop layout information correlated with the application software stored in the server; and a layout module for changing desktop layout of the application software in the terminal according to the desktop layout information. The server includes a correlation module for correlating desktop layout information with application software at the server. Usability and stability of the terminal desktop are improved. A better feeling in using the terminal desktop is provided.

### FIELD OF THE INVENTION

The present invention relates to the field of terminal data processing, and in particular relates to a terminal desktop processing system, a terminal, a server and a method.

### BACKGROUND OF THE INVENTION

Many types of network application software, such as instant messaging tools including MSN, Fetion, etc., have been developed and accepted by the majority of end-users, becoming indispensible user software tools that are widely used not only in the casual entertainments, but also in the users' daily work.

In prior art, a terminal desktop system is a commonly-used structure of terminal software system for end-users to use various software conveniently. When a variety of application software are running in the terminal desktop system, the user can arrange the layout of the displayed window of the application software such as the size and location etc. by dragging or other operations to facilitate operating according to their own habits.

However, with the development of technology, a lot of applications, such as instant messaging tools including MSN, Fetion, etc., have been provided with many additional features (i.e. value-added services) so as to meet the need of competition and to attract users. In addition, the application software become applicable to various network terminals, such that the user can either use a computer (PC) to log in the application software via Internet, or to use different mobile terminals to log in via mobile communication network such as TD-WCDMA. Due to different display resolutions and sizes of different terminal desktop systems, the user may have to re-arrange the desktop layout of application software and their additional features when using application software in different terminals, which results in inconvenient operation and unstable desktop of applications, making the user feel tired and affecting the security of applications. Hence, there is an urgent need to improve the terminal desktop system of network application software.

### SUMMARY OF THE INVENTION

Present invention provides a terminal desktop processing system, a terminal, a server and a method, which improve the usability and stability of terminal desktop, making users feel better when using the terminal desktop.

A terminal desktop processing system, provided to achieve the object of the present invention, includes:

a terminal, configured to execute network application software; and

a server, connected to the terminal via a network;

the terminal includes:

a scanning module, configured to scan desktop layout of the application software, and to obtain desktop layout information of the application software; and

a transmission module, configured to transmit the desktop layout information of the application software obtained by the scanning module to the server via the network; and

the server includes:

a correlation module, configured to correlate the desktop layout information with the application software at the server end after receiving the desktop layout information related to the application software.

A terminal for executing network application software is further provided to achieve the object of the present invention, includes:

a scanning module, configured to scan desktop layout of application software, and to obtain the desktop layout information of the application software; and

a transmission module, configured to transmit the desktop layout information of the application software obtained by the scanning module to the server via a network.

A server is further provided to achieve the object of the present invention, which is connected to the terminal executing the network application software via the network. The server includes:

a correlation module, configured to correlate the desktop layout information with the application software at the server end after receiving the desktop layout information related to the application software.

A terminal desktop processing method is further provided to achieve the object of the invention, which is based on the hardware architecture of the terminal for executing network application software and a server connected to the terminal via a network. The terminal includes the following steps:

Step A: the terminal scans the desktop layout of the application software, and obtains the desktop layout information of the application software;

Step B: the terminal transmits the desktop layout information of application software obtained to a server via the network; and

Step C: the server correlates the desktop layout information with the application software at the server after receiving the desktop layout information related to the application software.

The beneficial effect of the present invention is that the terminal desktop processing system, the terminal, the server and the method of the present invention allow the user to share the same desktop layout in different terminals by storing and reading the terminal desktop layout information. Thus, even when the user logins the same application software using different terminals, the same desktop layout of the application software saved can still be read, which improves the usability, stability and the security of the terminal desktop, making the user feel better when using the terminal desktop.

### BRIEF DESCRIPTION OF THE DRAWINGS

FIG. 1 is the schematic drawing showing the structure of the terminal desktop processing system of an embodiment of the present invention.

FIG. 2 is the schematic drawing showing the structure of the terminal desktop processing system of a further embodiment of the present invention.

FIG. 3 is the flow chart of the terminal desktop processing method of an embodiment of the present invention.

FIG. 4 is the flow chart of the terminal desktop processing method of a further embodiment of the present invention.

### DETAILED DESCRIPTION OF THE PREFERRED EMBODIMENTS

In order to make the technical solutions and advantages of the present invention more clear, the terminal desktop processing system, the terminal, the server and the method of the present invention will be further described in detail in the following with reference to the accompanying drawings and the embodiments. It will be appreciated that the embodiments described herein are to be considered in all respects as illustrative rather than limitative to the scope of the present invention.

In an embodiment as illustrated in FIG. 1, the terminal desktop processing system includes a terminal 10 configured to execute network application software and a server 20 connected to the terminal via a network.

The terminal 10 includes a scanning module 102, configured to scan desktop layout of the application software, and to obtain the desktop layout information of the application software.

Preferably, the desktop layout information refers to all window information contained in the desktop layout of the application software, including the rectangular area information occupied by each window of the desktop layout of the application software, which further includes the location, size and state information of each window of the desktop layout.

More preferably, the window information includes six parameters as follows:

an X parameter, representing the distance from the window to a point in the desktop (e.g. the upper left corner of the desktop) in horizontal direction;

a Y parameter, representing the distance from the window to a point in the desktop (e.g. the upper left corner of the desktop) in vertical direction;

a width parameter, representing the width occupied by the window;

a height parameter, representing the height occupied by the window;

a Z parameter, representing a stack-order of the windows; the lager the Z value is, the upper the window will be when it is stacked with the other windows; and

a window mode parameter (windowMode), representing a window state mode, such as maximized mode (max), restore mode (restore), etc.

A transmission module 103 is configured to transmit the desktop layout information of the application software obtained by the scanning module 102 to the server 20 via a network.

The server 20 includes a correlation module 201, configured to correlate the desktop layout information with the application software at the server end after receiving the desktop layout information related to the application software.

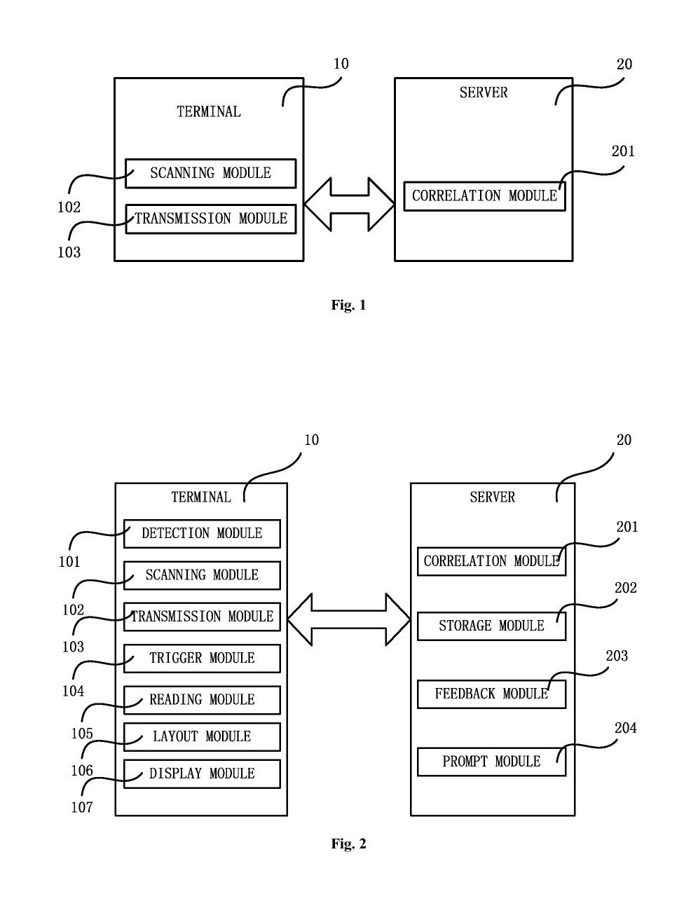

Preferably, as an embodiment, shown in FIG. 2, the terminal 10 further includes:

a reading module 105, configured to request the server 20 for the desktop layout information and to read the desktop layout information correlated with the application software stored in the server 20 end and correlate; and

a layout module 106, configured to change the layout of the application software in the terminal 10 according to the desktop layout information after the desktop layout information of the application software is read by the reading module 105.

Preferably, as an embodiment, the layout module 106 of the terminal 10 is also configured to change the rectangular area of each window one by one and the stack-order of the desktop window according to the desktop layout information, thereby changing the layout of the application software in the terminal 10.

More preferably, as an embodiment, shown in FIG. 2, the terminal 10 further includes:

a detection module 101, configured to detect and to start the storing of the desktop layout of the application software;

a trigger module 104, configured to trigger and to start updating the desktop layout of the application software when a user runs the application software in the terminal 10; and

a display module 107, configured to update the desktop system of the terminal 10 and to display the stored desktop layout of the application software after the layout of the application software is changed by the layout module 106.

Preferably, as an embodiment, shown in FIG. 2, the server 20 further includes:

a storage module 202, configured to save the desktop layout information of the application software which has been correlated by the correlation module 201;

a feedback module 203, configured to feed the prompt information about successful storage of the desktop layout information back to the terminal 10 after the desktop layout information of the application software is stored by the storage module 202; and

a prompt module 204, configured to determine whether there is correlated desktop layout information with the application software after the user runs the application software and connects it with the terminal via the network; in case there is correlated desktop layout information, the prompt module 204 sends a message to the terminal to prompt the user to update the desktop layout by using the stored desktop layout information.

The terminal 10 determines whether to trigger the updating of the desktop layout according to the prompt message sent by the prompt module 204 of the server 20.

The terminal 10 in the embodiment of the present invention can be various kinds of terminals that are connected to the server 20 via a network and can execute the network application software, including but not limited to a computer terminal, a variety of mobile terminals, a PDA terminal, or a reader terminal (e.g. iPAD), etc.

The network in the embodiment of the present invention can be various interconnected networks having terminals and server architectures, including but not limited to the Internet, local area network, the mobile communication network (e.g. WCDMA, TD-CDMA, CDMA2000, TD-LTE, LTE etc.), Wi-Fi network, Bluetooth network, etc.

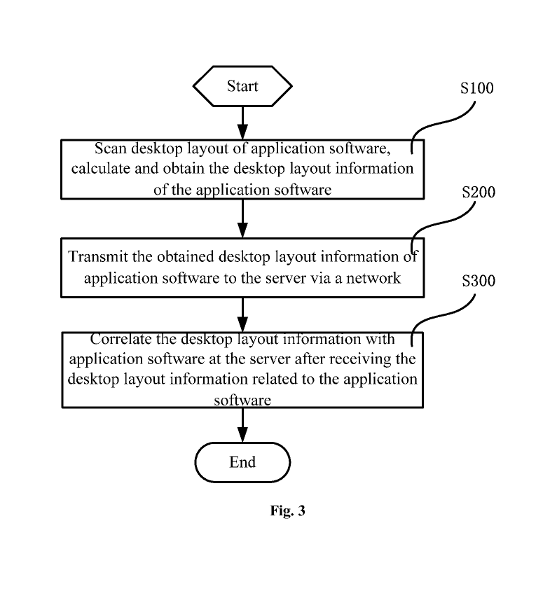

Accordingly, as shown in FIG. 3, a terminal desktop processing method is also provided in the present invention, which is based on the hardware architecture of a terminal for executing network application software and a server connected to the terminal via network, the method including the following steps.

Step S100: the terminal scans the desktop layout of the application software, and obtains the desktop layout information of the application software.

The terminal scans all the windows of the desktop layout of the current application software, obtaining the rectangular area occupied by each window of the desktop of the application software, and also obtaining the information of each window by setting a point on the desktop of the application software (e.g. the upper left corner of desktop) as the original point.

Preferably, the step of obtaining the information of each window specifically includes: decomposing each window into six parameters of each window of the desktop of the application software as follows:

an X parameter, representing the distance from the window to a point of the desktop (e.g. the upper left corner of the desktop) in horizontal direction;

a Y parameter, representing the distance from the window to a point of the desktop (e.g. the upper left corner of the desktop) in vertical direction;

a width parameter, representing the width occupied by the window;

a height parameter, representing the height occupied by the window;

a Z parameter, representing a stack-order of the window; the lager the Z value is, the upper the window will be when it is stacked with the other windows; and

a window mode parameter (windowMode), representing a window state mode, such as maximized mode (max), restore mode (restore), etc.

More preferably, as an applicable mode, if the window mode parameter (windowMode) is “restore”, then the decomposing of the window into the four parameters of X, Y, width and height can be calculated by two methods as follows.

1) calculating the parameters according to the percentage of window pixels in the desktop, such that when the resolution of the terminal changes, the desktop can still maintain visual consistency;

for example, the parameter of width or height percentage is calculated as follows:

parameter of width or height percentage=pixels/desktop width or height; and

2) calculating the parameters directly based on the pixel values, which is suitable for fixed-size windows.

Step S200: the terminal transmits the desktop layout information of the application software obtained to the server via network.

The terminal obtains the desktop layout information of all windows of the network application software and transmits the information to the server to correlate and store.

Step S300: the server correlates the desktop layout information with the application software at the server after receiving the desktop layout information related to the application software.

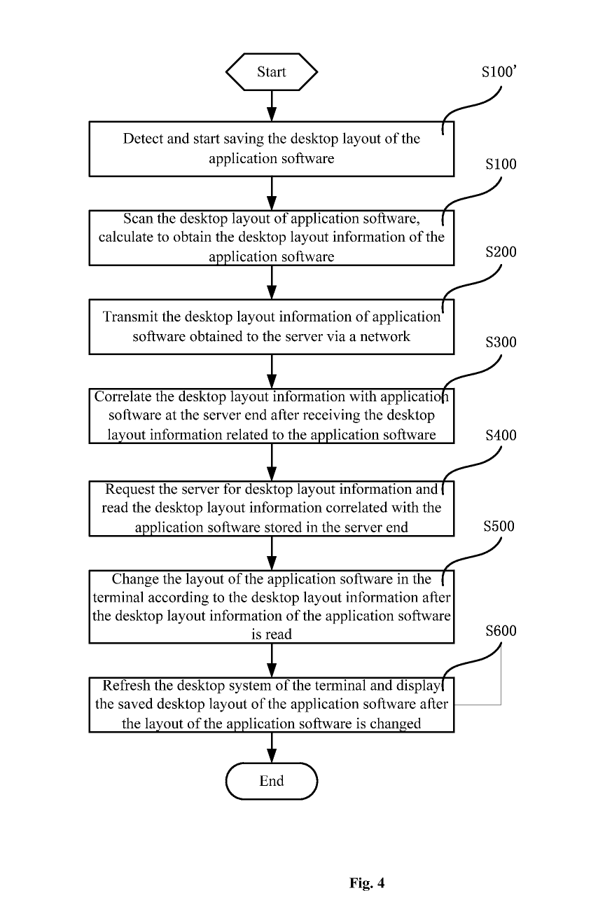

Preferably, as an embodiment shown in FIG. 4, the terminal desktop processing method of the present invention further includes the following steps.

Step S400: the terminal requests the server for the desktop layout information and reads the desktop layout information correlated with the application software stored in the server end.

Step S500: the terminal changes the layout of the application software in the terminal according to the desktop layout information after reading the desktop layout information of the application software.

The terminal changes the rectangular area of each window one by one and the stack-order of the desktop window according to the desktop layout information, so as to change the layout of the application software in the terminal.

Preferably, the window state mode (windowMode) is set according to data values; when the window state mode is “restore”, there will be two different situations with regard to the changing process according to the way by which the desktop layout information is stored.

1) If the parameters are calculated based on the percentage of pixel values in the window when saving the window information, then the changing process is calculated based on the pixel values:

setting the X, Y, width and height of the window directly as pixel values stored by the user.

2) If the parameters are calculated according to a percentage value of window pixels in the desktop when saving the window information, then calculation is based on the percentage: first convert the percentage into pixel values, then set the X, Y, width and height of the window as the pixel values stored by the user.

For example, the width or height is calculated as follows.

Method for calculation: width or height percentage parameter x current width or height of the desktop window.

More preferably, as an embodiment, shown in FIG. 4, the terminal desktop processing method of the present invention further includes the following step before the step S100:

Step S100′: the terminal detects and starts storing the desktop layout of the application software;

As an embodiment, the terminal detects the desktop change of the application software at certain times and starts saving the desktop layout of the application software; or the terminal detects that the user has pressed the key in the terminal and starts the storing of the desktop layout of the application software.

More preferably, as an embodiment, the method further includes the following steps after step S300.

Step S310: the server stores the correlated desktop layout information of the application software correlate.

Step S320: the server feeds feed the prompt information about successful storage of the desktop layout information back to the terminal after the desktop layout information of the application software is stored by the server.

More preferably, the method further includes the following steps before step S400.

Step S410′: to trigger and start updating the desktop layout of the application software when the user is running the application software in the terminal.

Step S420′: when the application software is started by the user and connected to the server end via network, the server determines whether there is correlated desktop layout information with the application software by with the terminal.

Step S430′: if no, then end and return; otherwise, in case there is correlated desktop layout information, the server sends a prompt message to the terminal to prompt the user to update the desktop layout by using the stored desktop layout information.

Step S440′: the terminal determines whether to trigger the updating of the desktop layout according to the prompt message sent by the server.

More preferably, the method further includes the following step after step S500.

Step S600: the terminal updates the desktop system of the terminal and displays the stored desktop layout of the application software after the terminal changes the layout of the application software.

The terminal desktop processing system, the terminal, the server and the method of the present invention allow the user to share the same desktop layout in different terminals by storing and reading the terminal desktop layout information, such that even if the user logs in the same application software using different terminals, the same desktop layout of the application software stored can still be read, which improves the usability, stability and the security of the terminal desktop and makes the user feel better when using the terminal desktop.

Finally, it should be noted that modifications and variations can be made by the skilled in the art, which will be within the scope of the present invention. Therefore, if the modifications and variations of the present invention are within the scope of the claims and their equivalent technology, then the present invention is also intended to include these modifications and variations.

1. A terminal desktop processing system, comprising:
a terminal, configured to execute network application software; and
a server, connected to the terminal via a network,
wherein, the terminal comprises:
a scanning module, configured to scan desktop layout of the network application software and to obtain desktop layout information of the network application software; and
a transmission module, configured to transmit the desktop layout information of the network application software obtained by the scanning module to the server via the network; and
the server comprises:
a correlation module, configured to correlate the desktop layout information with the network application software at the server after receiving the desktop layout information related to the network application software.

2. The terminal desktop processing system of claim 1, wherein:
the terminal further comprises:
a reading module, configured to request the server for the desktop layout information of the network application software, and to read the desktop layout information correlated with the network application software stored in the server; and
a layout module, configured to change desktop layout of the network application software in the terminal according to the desktop layout information after the reading module reads the desktop layout information of the network application software.

3. The terminal desktop processing system of claim 2, wherein:
the server further comprises:
a storage module, configured to store the desktop layout information of the network application software correlate by the correlation module;
a feedback module, configured to feed the prompt information about successful storage of the desktop layout information back to the terminal after the desktop layout information of the network application software is stored by the storage module; and
a prompt module, configured to determine whether there is correlated desktop layout information for the network application software when the network application software is started by the user and connected to the server via the network, and to send a prompt message to the terminal to prompt the user to update the desktop layout by using the stored desktop layout information when there is correlated desktop layout information; and
the terminal further comprises:
a detection module, configured to detect and start storing the desktop layout of the network application software;
a trigger module, configured to trigger and start updating the desktop layout of the network application software when a user runs the network application software in the terminal; and
a display module, configured to update the desktop system of the terminal and to display the stored desktop layout of the network application software after the desktop layout of the network application software is changed by the layout module.

4. The terminal desktop processing system of claim 1, wherein the desktop layout information refers to all window information in the desktop layout of the network application software, including rectangular area information occupied by each window of the desktop layout of the network application software, which further includes location, size and state information of each window of the desktop layout.

5. The terminal desktop processing system of claim 4, wherein the window information comprises six parameters as follows:
an X parameter, representing a distance from the window to a point of desktop in horizontal direction;
a Y parameter, representing a distance from the window to a point of desktop in vertical direction;
a width parameter, representing a width occupied by the window;
a height parameter, representing a height occupied by the window;
a Z parameter, representing a stack-order of the window; and
a window mode parameter, representing a window state mode.

6. A terminal for executing network application software, comprising:
a scanning module, configured to scan desktop layout of the network application software, and to obtain desktop layout information of the network application software; and
a transmission module, configured to transmit the desktop layout information of the network application software obtained by the scanning module to a server via a network.

7. The terminal of claim 6, further comprising:
a reading module, configured to request the server for the desktop layout information and to read the desktop layout information correlated to the network application software stored in the server; and
a layout module, configured to change the desktop layout of the network application software in the terminal according to the desktop layout information, after reading the desktop layout information of the network application software by the reading module.

8. The terminal of claim 7, further comprising:
a detection module, configured to detect and to start the storing of the desktop layout of the network application software;
a trigger module, configured to trigger and to start updating the desktop layout of the network application software when a user runs the network application software in the terminal; and
a display module, configured to update the desktop system of the terminal and to display the stored desktop layout of the network application software after the layout of the network application software is changed by the layout module.

9. The terminal of claim 6, wherein the desktop layout information refers to all window information in the desktop layout of the network application software, including rectangular area information occupied by each window of the desktop layout of the network application software, which further includes location, size and state information of each window of the desktop layout.

10. The terminal of claim 9, wherein the window information comprises six parameters as follows:
an X parameter, representing a distance from the window to a point of desktop in horizontal direction;
a Y parameter, representing a distance from the window to a point of desktop in vertical direction;
a width parameter, representing a width occupied by the window;
a height parameter, representing a height occupied by the window;
a Z parameter, representing a stack-order of the window; and
a window mode parameter, representing a window state mode.

11. The terminal of claim 9, wherein the layout module is further configured to change a rectangular area of each window and the stack-order of the desktop window one by one according to the desktop layout information.

12. A server, connected to the terminal running network application software via a network, comprising:
a correlation module, configured to correlate desktop layout information with the network application software at the server after receiving the desktop layout information related to the network application software.

13. The server of claim 12, further comprising:
a storage module, configured to store the desktop layout information of the network application software, which has been correlated by the correlation module;
a feedback module, configured to feed the prompt information about successful storage of the desktop layout information back to the terminal after the desktop layout information of the network application software is stored by the storage module; and
a prompt module, configured to determine whether there is correlated desktop layout information for the network application software when the network application software is started by the user and connected to the server via the network, and to send a prompt message to the terminal to prompt the user to update desktop layout by using the stored desktop layout information when there is correlated desktop layout information.

14. A method for terminal desktop processing, based on hardware architecture of a terminal for executing network application software and a server connected with the terminal via a network, comprising:
scanning, by the terminal, a desktop layout of the network application software, and obtaining desktop layout information of the network application software;
transmitting, by the terminal, the desktop layout information of the network application software obtained to a server via the network; and
correlating, by the server, the desktop layout information with the network application software at the server after receiving the desktop layout information related to the network application software.

15. The method of claim 14, further comprising:
requesting, by the terminal, the server for the desktop layout information and reading the desktop layout information correlated with the network application software stored in the server; and
changing, by the terminal, the layout of the network application software in the terminal according to the desktop layout information after reading the desktop layout information of the network application software.

16. The method of claim 14, further comprising:
before scanning:
detecting and starting, by the terminal, the storing of the desktop layout of the network application software; and
after correlating:
storing, by the server, the correlated desktop layout information of the network application software; and
feeding, by the server, the prompt information about a successful storage of the desktop layout information back to the terminal after the desktop layout information of the network application software is stored by the server.

17. The method of claim 15, further comprising:
before requesting:
triggering and starting, by the terminal updating of the desktop layout of the network application software when a user runs the network application software in the terminal;
determining, by the server, whether there is correlated desktop layout information for the network application software after the network application software is started by the user and connected with the server via the network;
if the correlated desktop layout information exists, then sending a message to the terminal to prompt the user to update the desktop layout by using the saved desktop layout information; otherwise, end and return; and
determining, by the terminal, whether to trigger the updating of the desktop layout according to the prompt message sent by the server; and
changing the layout:
updating, by the terminal the desktop system of the terminal and displaying the stored desktop layout of the network application software after the terminal changes the layout of the network application software.

18. The method of claim 17, wherein:
obtaining the desktop layout information of the network application software comprises:
scanning, by the terminal, all windows of the current desktop layout of the network application software, obtaining a rectangular area occupied by each window of the desktop of the network application software, and obtaining window information of each window by setting a point on the desktop as the original point;
obtaining window information of each window further comprises decomposing each window to obtain six parameters of each window of the desktop of the network application software, as follows:
an X parameter, representing a distance from the window to a point of desktop in horizontal direction;
a Y parameter, representing a distance from the window to a point of desktop in vertical direction;
a width parameter, representing a width occupied by the window;
a height parameter, representing a height occupied by the window;
a Z parameter, representing a stack-order of the windows in stack; and
a window mode parameter, representing a window state mode;
wherein changing of the layout of the network application software:
changing the rectangular area of each window one by one and the stack-order of the desktop window according to the desktop layout information.

19. The method of claim 18, wherein:
if the window mode parameter indicates restoration mode, then decomposing each window to obtain the four parameters of X, Y, width and height comprises:
calculating to obtain the parameters according to the percentage value of window pixels in the desktop;
changing the layout of the network application software in the terminal:
if the parameters are calculated according to a percentage value of pixels in the window when being stored, then calculating is based on the percentage value: first convert the parameters into pixel values, then set the X, Y, width and height of the window as the pixel values stored by the user.

20. The method of claim 18, wherein:
if the window mode parameter indicates restoration mode, then decomposing each window to obtain the four parameters of X, Y, width and height comprises:
calculating to obtain the parameters directly based on the pixel values;
changing the desktop layout of the network application software in the terminal comprises:
if the parameters are calculated directly based on the pixel values when being stored, the changing process is calculated based on the pixel values:
setting the X, Y, width and height of windows as the pixel values stored by the user.
